(19) United States
(12) Patent Application Publication
(10) Pub. No.: US 2025/0295057 A1
(43) Pub. Date: Sep. 25, 2025

(54) METHOD FOR DETERMINING LOCATION-SPECIFIC SEEDING RATE OR SEEDING DEPTH BASED ON SEEDING PARAMETERS ASSIGNED TO ZONES OF DIFFERENT LEVELS

(71) Applicant: BASF AGRO TRADEMAKRS GMBH, Ludwigshafen (DE)

(72) Inventors: Vagner PASOLIUS VEKSEL, Koeln (DE); Samuel Peter STEPHENSON, Malton (GB); Jens WEYEN, Krefeld (DE); Christian VON HEBEL, Koeln (DE)

(21) Appl. No.: 18/879,919

(22) PCT Filed: Jun. 27, 2023
(86) PCT No.: PCT/EP2023/067364

§ 371 Date: Dec. 30, 2024

(30) Foreign Application Priority Data
Jun. 29, 2022 (EP) 22182073.1

(51) Int. Cl. A01C 21/00; A01C 7/10

(52) U.S. Cl. CPC A01C 21/005; A01C 7/105

(57) ABSTRACT

A computer-implemented method for determining location-specific seeding rate and/or seeding depth for planting seeds in an agricultural field by means of an agricultural equipment, comprising the steps.
(step 1) identifying and/or indicating a parameter set comprising at least two seeding parameters, wherein the seeding parameter is a parameter having an impact and/or a potential impact to the seeding rate and/or seeding depth,
(step 2) receiving by the computing unit-from a database and/or from user input-field data, data indicative of the characteristics of the at least two seeding parameters of the parameter set, and data indicative of the agricultural equipment setup
(step 3) based on the field data, determining at least one level 1 zone, at least two level 2 zones and at least four level 3 zones,
(step 4) based on the data indicative of the characteristics of the at least two seeding parameters of the parameter set, and/or based on the data indicative of the equipment setup, determining for each seeding parameter whether it is a
   level 1 parameter, level 2 parameter, or level 3 parameter,
(step 5) if at least one level 1 parameter is present, generating a seeding logic for level 1 parameter(s),
(step 6) if at least one level 2 parameter is present, generating a seeding logic for level 2 parameter(s), based on the seeding logic for level 1 parameter(s),
(step 7) if at least one level 3 parameter is present, generating a seeding logic for level 3 parameter(s), based on the seeding logic for level 1 parameter(s) and on the seeding logic for level 2 parameter(s),
(step 8) outputting the seeding rate and/or the seeding depth based on the determined seeding logics.

### FIELD OF THE INVENTION

The present invention relates to a computer-implemented method for determining location-specific seeding rate and/or seeding depth based on multiple seeding parameters such as crop, field, yield, weather, and/or soil parameters which are assigned to zones of three levels, a data processing system comprising means for carrying out such computer-implemented method, the use of the determined location-specific seeding rate and/or seeding depth for controlling an agricultural equipment, and the use of the determined location-specific seeding rate and/or seeding depth for treating an agricultural field.

### BACKGROUND OF THE INVENTION

In practice, the farmer or user often faces the challenge that he/she cannot determine the optimal location-specific seeding rate, and/or seeding depth, in a systematic way, although all the data or information about the different seeding-relevant parameters of the field or the sub-field zone—including for example altitude, elevation, historical yield potential, soil texture, soil moisture—are in principle available or can be made available. This may lead to the problem that the seeding rate, or the seeding depth selected by the farmer or user is inappropriate or inefficient for achieving either the best yield, or the best crop value in terms of oil, protein, or nutrient content, or the best sustainability effect in terms of the minimized use of crop protection agent. Particularly, some seeding-relevant parameters might be static (or non-changing) or almost static in the entire field or entire geographic region, while other seeding-relevant parameters might change from one small sub-zone (ranging e.g. from 1 squaremeter to 100 squaremeters) to another such sub-zone.

In the prior art, WO 2013/169349 A1 discloses a method for forecasting optimum planting time, based on meterological data and soil temperature. WO 2013/169349 A1 does not disclose a systematic approach for determining zone-specific seeding rate, or seeding depth.

In view of the above problem and challenge, it was found that there is a need to improve and simplify the decision process of the farmer or user in this regard.

### SUMMARY OF THE INVENTION

In view of the above, it is an object of the present invention to provide a computer-implemented method for determining location-specific seeding rate and/or seeding depth for planting seeds in an agricultural field based on multiple seeding-relevant parameters. It is also an object of the present invention to provide a computer-implemented method for determining location-specific seeding rate and/or seeding depth, which supports fast, real-time and efficient decision-making for a farmer or user regarding the treatment of an agricultural field. It is also an object of the present invention to provide a computer-implemented method for determining the location-specific seeding rate and/or seeding depth, which enables the output of an application map which may be used for controlling an agricultural equipment. It is also an object of the present invention to provide a computer-implemented method to improve the yield of the crops planted in an agricultural field. It is also an object of the present invention to provide a computer-implemented method to improve the crop value, including the oil content, protein content, or nutrient content of the crops planted in an agricultural field. It is also an object of the present invention to provide a computer-implemented method to minimize the use of crop protection agents such as herbicides, fungicides, or insecticides, for growing a crop in an agricultural field. It is particularly also an object of the present invention to minimize the resources used for real-time measurements.

In this context real-time may mean without major delays, e.g. with a delay lower than 10 ms or lower than 1 s. In another interpretation real-time means that the reaction time is below a predefined maximum time value, wherein the time value may be selected from the range of 1 ms to 1 s.

The objects of the present invention are solved with the subject matter of the independent claims, wherein further embodiments are incorporated in the dependent claims. It should be noted that the following described aspects and examples of the invention apply for the method as well as for the data processing system, the computer program product and the computer-readable storage medium.

According to the first aspect of the present invention, the present invention relates to: A computer-implemented method for determining location-specific seeding rate and/or seeding depth for planting seeds in an agricultural field by means of an agricultural equipment, comprising the steps:
(step 1) identifying and/or indicating a parameter set comprising at least two seeding parameters, wherein the seeding parameter is a parameter having an impact and/or a potential impact to the seeding rate and/or seeding depth,
(step 2) receiving by the computing unit—from a database and/or from user input—
   a) field data,
   b) data indicative of the characteristics of the at least two seeding parameters of the parameter set, and
   c) data indicative of the agricultural equipment setup,
(step 3) based on the field data, determining at least one level 1 zone, at least two level 2 zones and at least four level 3 zones, wherein the level 1 zone comprises at least two level 2 zones, and the level 2 zone comprises at least two level 3 zones,
(step 4) based on the data indicative of the characteristics of the at least two seeding parameters of the parameter set, and/or based on the data indicative of the equipment setup, determining for each seeding parameter whether it is a
   a) level 1 parameter, being a seeding parameter which is changing or potentially changing (preferably beyond a predetermined threshold) when moving from one level 1 zone to another level 1 zone, or
   b) level 2 parameter, being a seeding parameter which is changing or potentially changing (preferably beyond a predetermined threshold) when moving from one level 2 zone to another level 2 zone, or
   c) level 3 parameter, being a seeding parameter which is changing or potentially changing (preferably beyond a predetermined threshold) when moving from one level 3 zone to another level 3 zone,
(step 5) if at least one level 1 parameter is present, generating a seeding logic for level 1 parameter(s),
(step 6) if at least one level 2 parameter is present, generating a seeding logic for level 2 parameter(s), based on the seeding logic for level 1 parameter(s),
(step 7) if at least one level 3 parameter is present, generating a seeding logic for level 3 parameter(s), based on the seeding logic for level 1 parameter(s) and on the seeding logic for level 2 parameter(s),
(step 8) outputting the location-specific seeding rate and/or the seeding depth based on the determined seeding logics.

Level 1 may be named first level, level 2 may be named second level and level 3 may be named third level.

The agricultural equipment setup is understood to be the existence, availability and properties of agricultural equipment usable for planting seeds or agricultural equipment usable for conducting real-time measurements of seeding parameters. E.g. whether a real-time soil moisture sensor and/or soil temperature sensor and/or soil nutrient sensor and/or sensors to determine the vertical soil structure, soil layering, soil horizons, and/or soil profile depth, is available, would be part of the agricultural equipment setup.

According to a preferred embodiment of the present invention, the seeding rate and/or the seeding depth is outputted as part of a control file usable for controlling an agricultural equipment capable of planting seeds.

According to a preferred embodiment of the present invention, the seeding rate and/or the seeding depth is outputted as part of an application map file usable for controlling an agricultural equipment capable of planting seeds.

According to a preferred embodiment of the present invention, the seeding parameter is a parameter selected from the group consisting of:
a) Soil parameters: soil texture, soil organic matter, soil pH, soil moisture, soil water content, soil temperature, soil compaction, soil capping, soil sandiness, soil electrical conductivity, soil structure, soil nutrient status, water holding capacity of the soil.
b) Yield parameters: biomass potential, yield potential, spatially explicit yield point data that enable to generate a map or a spatial yield map for the crop being planted, and average yield of the field related to the crop being planted, historical yield potential, historical actual yield, forecasted yield potential,
c) Crop parameters: targeted crop usage, plant variety, days to sexual maturity, seed vigor, emergence rating, expected germination percentage, seed size, seeding time, heat sum required for vegetative growth,
d) Field topography parameters: elevation, slope, topographic wetness index, curvature, orientation, aspect, exposure, and/or relief,
e) Field agronomy parameters: pest and disease risk, crop residue coverage, straw coverage, previous field treatment, previous crop planted,
f) Weather parameters: edapho-climatic region, temperature, air temperature, soil surface temperature, canopy temperature, humidity, air humidity, relative humidity, precipitation, snow, hail, moisture, wind condition, wind speed, and/or sunlight level.

The historical yield potential is preferably determined based on remotely sensed green-leaf area or biomass data of the field or the sub-field zone. A sub-field zone in an example may be a portion of the field and may have an area smaller than the filed. Thus, a sub-field zone may fit into a field. A field may comprise a plurality of different sub-field zones. A sub-field zone may have a smaller level than the field.

A soil parameter may describe the soil in the region of interest (ROI), e.g. the field to be used. The yield parameter may be a parameter expressing a probability for a yield. The crop parameter may express a property of a plant. A field topography parameter may describe the structure of a field in a space. A field agronomy parameter may be an indication of a state of a field. A weather parameter may describe an environmental impact to the field and/or the crop on the field.

Different seeding parameter may locally vary differently. A value of a seeding parameter that may slowly change when the location is varied may be associated with a coarse level, e.g. level 1. A value of a seeding parameter that may rapidly change when the location is varied may be associated with a granular level, e.g. level 3.

In other words, parameter that may vary stronger over the same distance may be associated with a higher level. Thus, a parameter of a higher level may be more sensitive to a change of the location.

According to a preferred embodiment of the present invention, the size of the level 1 zone is from 10 km² to 100,000 km².

According to a preferred embodiment of the present invention, the size of the level 2 zone is from 100 m² to 10 km².

According to a preferred embodiment of the present invention, the size of the level 3 zone is from 0.0001 m² to 100 m².

According to a preferred embodiment of the present invention, the size of level 1 zone is from 10 km² to 100,000 km², the size of level 2 zone is from 10000 m² to 10 km², the size of level 3 zone is from 0.0001 m² to 10000 m² (Variant A).

According to a preferred embodiment of the present invention, the size of level 1 zone is from 1 km² to 100,000 km², the size of level 2 zone is from 1000 m² to 1 km², the size of level 3 zone is from 0.0001 m² to 1000 m² (Variant B).

According to a preferred embodiment of the present invention, the size of level 1 zone is from 10 km² to 100,000 km², the size of level 2 zone is from 1000 m² to 10 km², the size of level 3 zone is from 0.0001 m² to 1000 m² (Variant C).

According to a preferred embodiment of the present invention, the size of level 1 zone is from 1 km² to 100,000 km², the size of level 2 zone is from 100 m² to 1 km², the size of level 3 zone is from 0.0001 m² to 100 m² (Variant D).

In other words, the area of a level 1 zone is larger than the area of a level 2 zone and the area of a level 2 zone is larger than the area of a level 3 zone. In this way level 1 may have a coarse resolution and level 3 may have granular resolution and the resolution may scale down from level 1 to level 3 via level 2.

In other words, the size of the zone may determine how often a seeding parameter is checked and/or sampled and thus how often the seeding rate and/or seeding depth may be adapted to new conditions.

For example, an edapho-climatic region may be a seeding parameter for a large zone of level 1 that stays substantially constant, whereas precipitation may be a seeding parameter of level 2, and soil moisture may be a seeding parameter of level 3.

According to a preferred embodiment of the present invention, the level 3 parameters are obtained and/or updated by real-time measurements.

According to a preferred embodiment of the present invention, the level 2 parameters are obtained and/or updated by real-time measurements only when the agricultural equipment moves from one level 2 zone to another level 2 zone. In an example the agricultural equipment moves from one level 2 zone to another level 2 zone within the field or farm size.

According to a preferred embodiment of the present invention, the level 3 parameters are obtained and/or updated by real-time measurements, and the level 2 parameters are obtained and/or updated by real-time measurements only when the agricultural equipment moves from one level 2 zone to another level 2 zone. In other words the level 3 parameters are obtained and/or updated and the level 2 parameters are obtained and/or updated when the parameter changes at level 2 within the field or farm and the agricultural equipment crosses such a zone boundary.

According to a preferred embodiment of the present invention, the timeframe between obtaining and/or updating the level 3 parameters by real-time measurements and outputting the seeding rate and/or seeding depth is from 1 millisecond to 5 minutes, preferably from 1 millisecond to 60 seconds, more preferably from 1 millisecond to 5 seconds.

According to a preferred embodiment of the present invention, the parameter set comprises at least three seeding parameters, more preferably at least four seeding parameters, most preferably at least five seeding parameters, particularly at least six seeding parameters.

According to a preferred embodiment of the present invention, the parameter set comprises at least three seeding parameters, and wherein at least one of said seeding parameters is determined as level 1 parameter, at least one of said seeding parameters is determined as level 2 parameter, and at least one of said seeding parameters is determined as level 3 parameter. In other words, the seeding parameter may be refined by different levels.

According to a further aspect of the present invention, the present invention relates to: A data processing system comprising means for carrying out the computer-implemented method according to the present invention.

According to a further aspect of the present invention, the present invention relates to: A computer program product comprising instructions which, when the program is executed by a computer, cause the computer to carry out the computer-implemented method according to the present invention.

According to a further aspect of the present invention, the present invention relates to: A computer-readable storage medium comprising instructions which, when executed by a computer, cause the computer to carry out the computer-implemented method according to the present invention.

According to a further aspect of the present invention, the present invention relates to the use of the determined location-specific seeding rate and/or seeding depth for controlling an agricultural equipment, and/or the use of the determined location-specific seeding rate and/or seeding depth for treating an agricultural field.

According to a further aspect of the invention, the yield parameter include: Historical yield potential of the field or the sub-field zone, wherein the historical yield potential is preferably determined based on remotely sensed green-leaf area or biomass data of the field or sub-field zone. The historical yield potential can be preferably indicated in a historic yield potential map showing the historical yield potentials of different sub-field zones (e.g. “Powerzone maps”). The historical yield potential can be preferably determined based on remotely sensed green-leaf area or biomass data of the corresponding field or sub-field zone of not less than the last 2 years, more preferably not less than the last 4 years, most preferably not less than the last 6 years, particularly not less than the last 8 years, particularly preferably not less than the last 10 years. In this context, the term “remotely sensed” preferably means: remotely sensed by satellite, airplane, unmanned aerial vehicle, drone, optical sensor, or LiDAR sensor. A Powerzone map may show sub-field zones with different historical yield potentials. Harvesting may not be necessary in order to determine historical yield potential. In other words, the historical yield potential may be determined remotely before harvesting. The historical actual yield potential may be determined by actual harvest data.

According to a further aspect of the invention, the yield parameter include: Historical actual yield of the field or the sub-field zone, determined based on the amounts harvested in the past from the field or the sub-field zone. The historical actual yield can be determined based on the amounts harvested from the field or the sub-field zone in the past of not less than the last 2 years, more preferably not less than the last 4 years, most preferably not less than the last 6 years, particularly not less than the last 8 years, particularly preferably not less than the last 10 years.

According to a further aspect of the invention, the yield parameter include: Forecasted yield potential of the field or the sub-field zone, wherein the forecasted yield potential is preferably estimated based on the historic yield potential and/or the historical actual yield and optionally based on weather forecasts (e.g. weather forecasts for the duration of the entire crop season, using specific weather models), or wherein the forecasted yield potential is estimated based on yield prediction models, i.e. prediction models for yield parameter.

According to a further aspect of the invention, the yield parameter include
a) Historical yield potential of the field or the sub-field zone, wherein the historical yield potential is preferably determined based on remotely sensed green-leaf area or biomass data of the field or the sub-field zone, and
b) Historical actual yield of the field or the sub-field zone, determined based on the amounts harvested in the past from the field or the sub-field zone, wherein the historical yield potential (referred to as “HYP”) and historical actual yield parameter (referred to as “HAY”) are preferably combined with predefined or user-defined weighting factors. In another preferred embodiment, the historical yield potential and historical actual yield parameter may be combined with X % weighting regarding HYP and Y % weighting regarding HAY, e.g. the final yield parameter relating to the field or the sub-field zone is calculated with the formula X %*HYP+Y %*HAY, with X % being preferably in the range of 10% to 90%, more preferably in the range of 20% to 80%, most preferably in the range of 30% to 70%, with Y % being preferably in the range of 10% to 90%, more preferably in the range of 20% to 80%, most preferably in the range of 30% to 70%, and with X % and Y % totaling 100%. In a preferred embodiment, the historical yield potential (referred to as “HYP”) and historical actual yield (referred to as “HAY”) data may be combined with each 50% weighting, e.g. the final yield parameter relating to the field or the sub-field zone is calculated with the formula 50%*HYP+50%*HAY. In another preferred embodiment, the historical yield potential and historical actual yield parameter may be combined with 30% weighting regarding HYP and 70% weighting regarding HAY, e.g. the final yield parameter relating to the field or the sub-field zone is calculated with the formula 30%*HYP+70%*HAY. In another preferred embodiment, the historical yield potential and historical actual yield parameter may be combined with 70% weighting regarding HYP and 30% weighting regarding HAY, e.g. the final yield parameter relating to the field or the sub-field zone is calculated with the formula 70%*HYP+30%*HAY.

Field data are preferably data indicative of the field size, or field geometries, or GPS coordinates of the field midpoint to enable field boundary detection, or the field boundary with spatial coordinates (e.g., a shape file with polygon surrounding the field) or other some digital format containing the coordinates of the field.

Sub-field zone data are preferably data indicative of the Sub-field zone size, or Sub-field zone geometries, or GPS coordinates of the Sub-field zone midpoint to enable Sub-field zone boundary detection, or the Sub-field zone boundary with spatial coordinates (e.g., a shape file with polygon surrounding the Sub-field zone) or other some digital format containing the coordinates of the Sub-field zone.

In the context of the present invention, the term “include” means “comprise”.

In the context of the present invention, the term “field” or “agricultural field” is understood to be any area in which crop plants, are produced, grown, sown, and/or planned to be produced, grown or sown. The term “field” or “agricultural field” may also include horticultural fields, and silvicultural fields.

In the context of the present invention, the term “Yield” is understood to be the harvested plant or crop biomass (e.g. indicated in tons or kilograms) per area unit (e.g. indicated in hectare or square meters) and per vegetation period (e.g. season), and yield is indicated for example as tons per hectare or kilograms per hectare. Notably, the term “yield” in the present disclosure can mean both, the so called “biological yield” and the so called “economic yield”. Preferably, “yield” means the biological yield. The “biological yield” is defined as “the total plant mass, including roots (biomass), produced per unit area and per growing season”. For the “economic yield”, “only those plant organs or constituents” are taken into account “around which the plant is grown”, wherein “a high biological yield is the basis for a high economic yield” (see Hans Mohr, Peter Schopfer, Lehrbuch der Pflanzenphysiologie, 3rd edition, Berlin/Heidelberg 1978, p. 560-561).

In the context of the present invention, “Seeding logic” is understood to be a logic or relationship between the change of seeding parameter(s) and the change of the seeding rate and/or seeding depth. In other words, a seeding logic may be seen as a decision engine that may receive a seeding parameter or a plurality of seeding parameters and based on a set of rules, e.g. hard wired rules and/or a machine learning algorithm, may adapt the seeding rate and/or seeding depth.

In the context of the present invention, “Seeding rate” is understood to be the seeding density (number of seeds per area, kilograms of seeds per area, or number of seeds per linear meter), e.g. 1000 seeds per ha, or number of seeds per linear meter. A linear meter is a meter measured along a seeding line without taking into account the breadth and/or width of the seeding line. In an example for wheat a seeding rate may be set as 130 kg of seeds per ha. In another example a predefined number of kernels per linear meter is set independently of the area to be treated. The seeding rate may be set in a treatment device, e.g. a seed drill or a planter.

Seeding time is preferably seeding date.

The impact of selected seeding parameters on the seeding rate and/or seeding depth is described in Table 1.

TABLE 1
Impact of seeding parameters on the
seeding rate and/or seeding depth

| | Impact on seeding rate | |
|---|---|---|
| Seeding parameter (P) | (SR) | Seeding depth (SD) |
| Soil Texture (e.g. USDA | Yes | Yes |
| triangle) | | |
| Soil Organic Matter | Yes (P+ SR−) | Yes (non-linear) |
| Soil pH | Yes (non-linear) | No |
| Soil Moisture | Yes (non-linear, as the | Yes (P+, SD−) |
| (Precipitation/Weather) | soil texture is also | |
| | relevant; normally, the | |
| | drier, the higher the | |
| | seeding rate, as it | |
| | influences the | |
| | germination rate | |
| Soil Temperature | Yes (P+ SR− linear to | Yes (non-linear) |
| | a certain limit) | |
| Soil compaction | Yes (P+ SR+) | Yes (non-linear) |
| Soil capping (surface | Yes (non-linear; | Yes (if you expect |
| compaction) | depending on the clay | capping, you will |
| | content) | change the seeding |
| | | depth so that |
| | | germination can occur |
| | | before capping) |
| biomass potential | Yes (P+ SR− for | No |
| | soybean; P+ SR+ for | |
| | corn) | |
| Seeding Time (preferably | Yes | Yes |
| seeding date) | | |
| “targeted usage of the | Yes | No |
| crop” (e.g. if soybean | | |
| goes to feed or will be | | |
| directly consumed to | | |
| humans or if plants will | | |
| be used as biofuels) | | |
| Plant variety | Yes | Yes |
| Edapho-climatic region | Yes | No |
| Elevation | Yes | Yes |
| Slope | Yes | Yes |
| Topographic wetness | Yes | Yes |
| index | | |
| Curvature | Yes | Yes |
| Aspect (orientation) | Yes | Yes (considering |
| | | shadow regions) |
| Crop residue/straw | Yes | Yes |
| coverage) | | |
| Previous field treatment | Yes | Yes |
| (e.g. if tillage has been | | |
| done) | | |
| Previous crop planted in | Yes | No |
| the field | | |
| Pest and disease risk in | Yes | Yes |
| the field | | |
| Seed size (i.e. how large | Yes | Yes |
| the seed is) | | |
| Expected germination | Yes | No |
| percentage (data coming | | |
| from test series, it's | | |
| printed on the seed bags) | | |
| Seed Vigor (e.g. speed of | Yes | Yes |
| germination) | | |

(Legend: “P+” means seeding parameter goes up; “P−” means seeding parameter goes down;: “SR+” means seeding rate goes up; “SR−” means seeding rate goes down; “SD+” means seeding density goes up; “SD−” means seeding density goes down)

For example, the symbol (P+ SR−) for the seeding parameter P of the soil temperature means that an increase of the soil temperature (P+) causes the seeding rate SR to go down (SR−).

An increase of the seeding parameter soil moisture (P+) decreases the seeding depth (SD−).

The seeding parameter may be detected by a corresponding sensor. The relation between seeding parameter and impact on seeding rate and/or seeding depth may be characterized by a characteristic, a characteristic curve and/or a transfer curve. Such a characteristic may be realized by a look up table.

The main advantage of the present invention is that the invention makes it possible to differentiate between seeding parameters which are changing in zones of different levels (level 1 zone is for example a whole landscape region, level 2 zone is for example an agricultural field, level 3 zone is a sub-field zone) and tailor the application of seeding logics or the use of resource-consuming real-time measurements (and real-time sensors) based on this differentiation. The size of the zones may be adapted to the changing rate. A climate parameter may be valid for a whole landscape region. A weather parameter may be valid for the whole field, ROI and/or region to be treated. A soil parameter may be valid for a subfield zone.

### FIGURES

FIG. 1 illustrates the workflow of the embodiment of the present invention as described in claim 1.

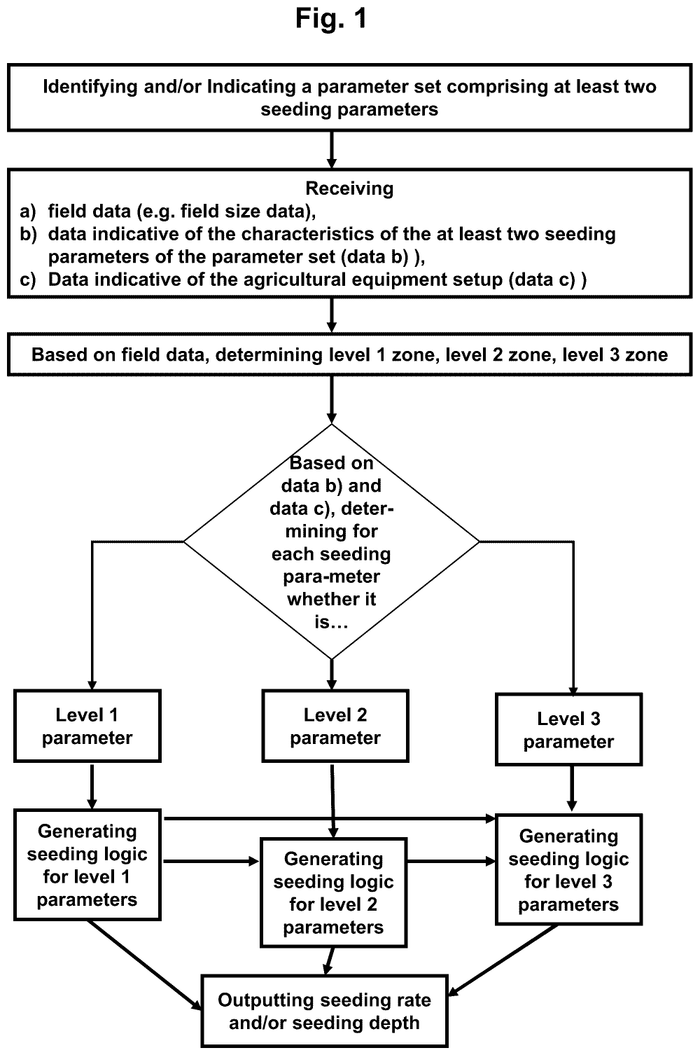

FIG. 2 schematically illustrates a treatment management system 500. The treatment parameters (i.e. seeding rate and/or seeding depth) determined by the computer-implemented method of the present invention will be outputted or further processed as a control signal for an agricultural equipment embedded in the treatment management system 500, wherein the agricultural equipment is preferably a seed drill or planter. The treatment management system 500 may comprise a seed drill or planter 510, a data management system 520, a field management system 112, and a client computer 540. The seed drill or planter 510 may be e.g. ground robots with variable-rate applicators, or other variable-rate applicators for applying seed products (particularly seeds and seedlings) to the field 502.

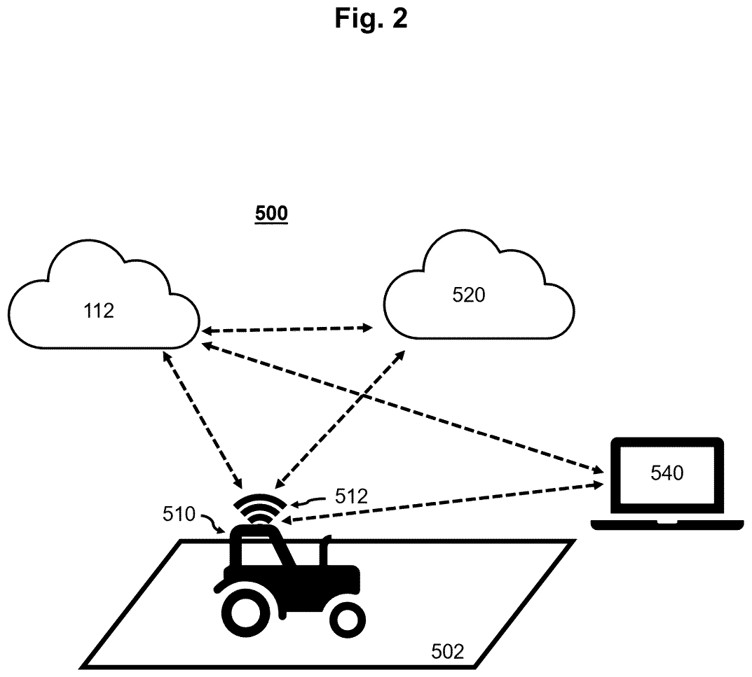

In the example of FIG. 2, the seed drill or planter 510 is embodied as smart farming machinery. The smart farming machinery 510 may be a smart seed drill or smart seed planter and includes a connectivity system 512. The connectivity system 512 may be configured to communicatively couple the smart farming machinery 510 to the distributed computing environment. It may be configured to provide data collected on the smart farming machinery 510 to the data management system 520, the field management system 112, and/or the client computer 540 of the distributed computing environment.

The data management system 520 may be configured to send data to the smart farming machinery 510 or to receive data from the smart farming machinery 510. For instance, as detected maps or as applied maps comprising data recorded during application on the field 502 may be sent from the smart farming machinery 510 to the data management system 520. For instance, the data management system 520 may comprise georeferenced data of different fields and the associated treatment map(s).

The field management system 520 may be configured to provide a control protocol, an activation code or a decision logic to the smart farming machinery 510 or to receive data from the smart farming machinery 510. Such data may also be received through the data management system 520.

The field computer 540 may be configured to receive a user input and to provide a field identifier and an optional treatment specifier to the field management system 112. Alternatively, the field identifier may be provided by the seed drill or planter 510. Alternatively, the optional treatment specifier may be determined using e.g. growth stage models, weather modelling, neighbouring field incidences, etc. The field management system 112 may search the corresponding agricultural field and the associated treatment map(s) in the data management system 520 based on the field identifier and the optional treatment specifier. The field computer 540 may be further configured to receive client data from the field management system 112 and/or the smart farming machinery 510. Such client data may include for instance application schedule to be conducted on certain fields with the smart farming machinery 510 or field analysis data to provide insights into the health state of certain fields.

The treatment device 510, the data management system 520, the field management system 112, and the client computer 540 may be associated with a network. For example, the network may be the internet. The network may alternatively be any other type and number of networks. For example, the network may be implemented by several local area networks connected to a wide area network. The network may comprise any combination of wired networks, wireless networks, wide area networks, local area networks, etc.

The data processing system of the present invention may be embodied as, or in, or as part of the field management system 112 to perform the above-described method to provide a control data to the smart farming machinery 510. For example, the field management system 112 may receive the seed drill/planter configuration data from the seed drill or planter 510 via the connectivity system 512. The field management system 112 may receive geodependent environmental data (e.g. temperature, moisture, humidity, and/or wind speed) form one or more sensors installed on the seed drill or planter 510 to monitor environmental data. Alternatively or additionally, the field management system 112 may receive geo-dependent environmental data from weather services.

1. A computer-implemented method for determining location-specific seeding rate and/or seeding depth for planting seeds in an agricultural field by means of an agricultural equipment, comprising the steps:
identifying and/or indicating a parameter set comprising at least two seeding parameters, wherein the seeding parameter is a parameter having an impact and/or a potential impact to the seeding rate and/or seeding depth,
receiving by the computing unit—from a database and/or from user input—
a) field data,
b) data indicative of the characteristics of the at least two seeding parameters of the parameter set, and
c) data indicative of the agricultural equipment setup.
based on the field data, determining at least one level 1 zone, at least two level 2 zones and at least four level 3 zones, wherein the level 1 zone comprises at least two level 2 zones, and the level 2 zone comprises at least two level 3 zones,
based on the data indicative of the characteristics of the at least two seeding parameters of the parameter set, and/or based on the data indicative of the equipment setup, determining for each seeding parameter whether it is a
a) level 1 parameter, being a seeding parameter which is changing or potentially changing when moving from one level 1 zone to another level 1 zone, or
b) level 2 parameter, being a seeding parameter which is changing or potentially changing when moving from one level 2 zone to another level 2 zone, or
c) level 3 parameter, being a seeding parameter which is changing or potentially changing when moving from one level 3 zone to another level 3 zone,
if at least one level 1 parameter is present, generating a seeding logic for level 1 parameter(s),
if at least one level 2 parameter is present, generating a seeding logic for level 2 parameter(s), based on the seeding logic for level 1 parameter(s),
if at least one level 3 parameter is present, generating a seeding logic for level 3 parameter(s), based on the seeding logic for level 1 parameter(s) and on the seeding logic for level 2 parameter(s), and
outputting the location-specific seeding rate and/or the seeding depth based on the determined seeding logics.

2. The computer-implemented method according to claim 1, wherein the seeding rate and/or the seeding depth is outputted as part of a control file usable for controlling an agricultural equipment capable of planting seeds.

3. The computer-implemented method according to claim 1, wherein the seeding rate and/or the seeding depth is outputted as part of an application map file usable for controlling an agricultural equipment capable of planting seeds.

4. The computer-implemented method according to claim 1, wherein the seeding parameter is a parameter selected from the group consisting of: soil parameters, yield parameters, crop parameters, field topography parameters, field agronomy parameters, and weather parameters.

5. The computer-implemented method according to claim 1, wherein the size of the level 1 zone is from 10 km² to 100,000 km².

6. The computer-implemented method according to claim 1, wherein the size of the level 2 zone is from 100 m² to 10 km².

7. The computer-implemented method according to claim 1, wherein the size of the level 3 zone is from 0.0001 m² to 100 m².

8. The computer-implemented method according to claim 1, wherein the level 3 parameters are obtained and/or updated by real-time measurements.

9. The computer-implemented method according to claim 1, wherein the level 2 parameters are obtained and/or updated by real-time measurements only when the agricultural equipment moves from one level 2 zone to another level 2 zone.

10. The computer-implemented method according to claim 1, wherein the timeframe between obtaining and/or updating the level 3 parameters by real-time measurements and outputting the seeding rate and/or seeding depth is from 1 millisecond to 5 minutes.

11. The computer-implemented method according to claim 1, wherein the parameter set comprises at least three seeding parameters.; more preferably at least four seeding parameters, most preferably at least five seeding parameters.

12. The computer-implemented method according to claim 1, wherein the parameter set comprises at least three seeding parameters, and wherein at least one of said seeding parameters is determined as level 1 parameter, at least one of said seeding parameters is determined as level 2 parameter, and at least one of said seeding parameters is determined as level 3 parameter.

13. A data processing system comprising means for carrying out the computer-implemented method according to claim 1.

14. A computer program product comprising instructions which, when the program is executed by a computer, cause the computer to carry out the computer-implemented method according to claim 1.

15. A computer-readable storage medium comprising instructions which, when executed by a computer, cause the computer to carry out the computer-implemented method according to claim 1.

16. The computer-implemented method according to claim 4, wherein:
the soil parameters are selected from the group consisting of soil texture, soil organic matter, soil pH, soil moisture, soil temperature, soil compaction, soil capping, soil sandiness, soil conductivity, and water holding capacity of the soil;
the yield parameters are selected from the group consisting of biomass potential, yield potential, spatially explicit yield point data that enable to generate a map or a spatial yield map for the crop being planted, and average yield of the field related to the crop being planted, historical yield potential, historical actual yield, and forecasted yield potential,
the crop parameters are selected from the group consisting of targeted crop usage, plant variety, days to sexual maturity, seed vigor, emergence rating, expected germination percentage, seed size, and seeding time,
the field topography parameters are selected from the group consisting of elevation, slope, topographic wetness index, curvature, orientation, aspect, exposure, and/or relief,
the field agronomy parameters are selected from the group consisting of pest and disease risk, crop residue coverage, straw coverage, previous field treatment, and previous crop planted, and
the weather parameters are selected from the group consisting of edapho-climatic region, temperature, air temperature, soil surface temperature, canopy temperature, humidity, air humidity, relative humidity, precipitation, snow, hail, moisture, soil moisture, soil water content, water content, wind condition, wind speed, and/or sunlight level.

17. The computer-implemented method according to claim 1, wherein the timeframe between obtaining and/or updating the level 3 parameters by real-time measurements and outputting the seeding rate and/or seeding depth is from 1 millisecond to 60 seconds.

18. The computer-implemented method according to claim 1, wherein the timeframe between obtaining and/or updating the level 3 parameters by real-time measurements and outputting the seeding rate and/or seeding depth is from 1 millisecond to 5 seconds.
